(19) United States
(12) Patent Application Publication
(10) Pub. No.: US 2014/0061485 A1
(43) Pub. Date: Mar. 6, 2014

(54) RADIATION IMAGING APPARATUS, METHOD FOR MANUFACTURING THE SAME, AND RADIATION IMAGING SYSTEM

(71) Applicant: CANON KABUSHIKI KAISHA, Tokyo (JP)

(72) Inventors: Kazumi Nagano, Honjo-shi (JP); Satoshi Okada, Tokyo (JP); Keiichi Nomura, Honjo-shi (JP); Yohei Ishida, Honjo-shi (JP)

(21) Appl. No.: 13/975,509

(22) Filed: Aug. 26, 2013

(30) Foreign Application Priority Data
Aug. 29, 2012 (JP) 2012-188925

(51) Int. Cl. G01T 1/20

(52) U.S. Cl. CPC G01T 1/2006
USPC 250/363.02; 250/366; 29/592.1

(57) ABSTRACT

A radiation imaging apparatus, comprising a sensor panel including a sensor array, a scintillator layer disposed on the sensor panel so as to cover the sensor array, and a housing having a side wall facing a side surface of the sensor panel and containing the sensor panel and the scintillator layer, wherein the scintillator layer protrudes, at at least one side of the sensor panel, from the side toward the side wall.

### BACKGROUND OF THE INVENTION

1. Field of the Invention

The present invention relates to a radiation imaging apparatus, a method for manufacturing the same, and a radiation imaging system.

2. Description of the Related Art

A radiation imaging apparatus D as a reference example will be described with reference to FIG. 8. The radiation imaging apparatus D can include a sensor array 20 including a plurality of sensors 21 designed to perform photoelectric conversion and arranged on a substrate 10 in the form of an array, a scintillator layer 30 disposed on the array, and a housing 40 for the installation of them.

Referring to FIG. 8, the arrows schematically show light generated in a region immediately above each sensor 21 on the scintillator layer 30. Although the amounts of light generated in the regions immediately above the respective sensors 21 on the scintillator layer 30 are uniform, the amounts of light entering the sensors 21 at the end region are smaller than at the central region. That is, although the light emitting efficiency of the scintillator layer 30 is uniform within its plane, the sensitivity of the radiation imaging apparatus D with respect to radiation is nonuniform within its plane because the amount of light received by each sensor 21 decreases in its end region.

Under the circumstance, there is conceivable a structure in which a sufficient distance L1 is secured from an end of the substrate 10 to the sensor array 20, and the scintillator layer 30 is formed to sufficiently cover the sensor array 20. This structure however increases a distance L2 from the housing 40 to the image sensing region (sensor array 20). This produces a dead space in the radiation imaging apparatus D. In a mammography apparatus, for example, since the distance from the chest region of a patient to an imaging region becomes large, the effective region of radiation imaging becomes small.

### SUMMARY OF THE INVENTION

The present invention provides a technique advantageous in equalizing the distribution of light generated in the scintillator layer.

One of the aspects of the present invention provides a radiation imaging apparatus, comprising a sensor panel including a sensor array, a scintillator layer disposed on the sensor panel so as to cover the sensor array, and a housing having a side wall facing a side surface of the sensor panel and containing the sensor panel and the scintillator layer, wherein the scintillator layer protrudes, at at least one side of the sensor panel, from the side toward the side wall.

Further features of the present invention will become apparent from the following description of exemplary embodiments with reference to the attached drawings.

### BRIEF DESCRIPTION OF THE DRAWINGS

FIGS. 1A and 1B are views for explaining an example of the arrangement of a radiation imaging apparatus;

FIG. 2 is an enlarged view for explaining an example of the arrangement of the radiation imaging apparatus;

FIGS. 3A to 3C are views for explaining another example of the arrangement of the radiation imaging apparatus;

FIGS. 4A to 4D are views for explaining still another example of the arrangement of the radiation imaging apparatus;

FIGS. 5A to 5C are views for explaining an example of a method for manufacturing a radiation imaging apparatus;

FIGS. 6A to 6E are views for explaining an example of the arrangement of a radiation imaging apparatus for a large screen;

FIG. 7 is a view for explaining an example of the arrangement of an imaging system; and

FIG. 8 is a view for explaining a reference example of the arrangement of the radiation imaging apparatus.

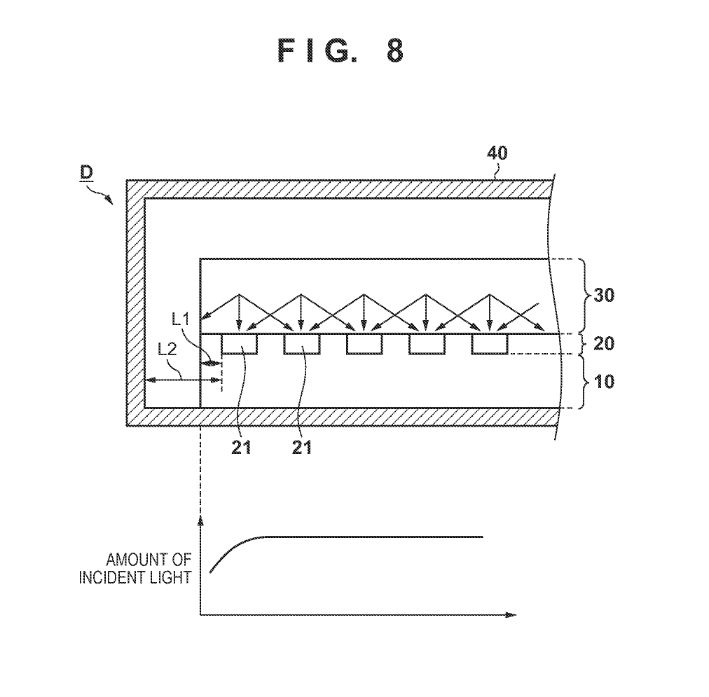

### DESCRIPTION OF THE EMBODIMENTS

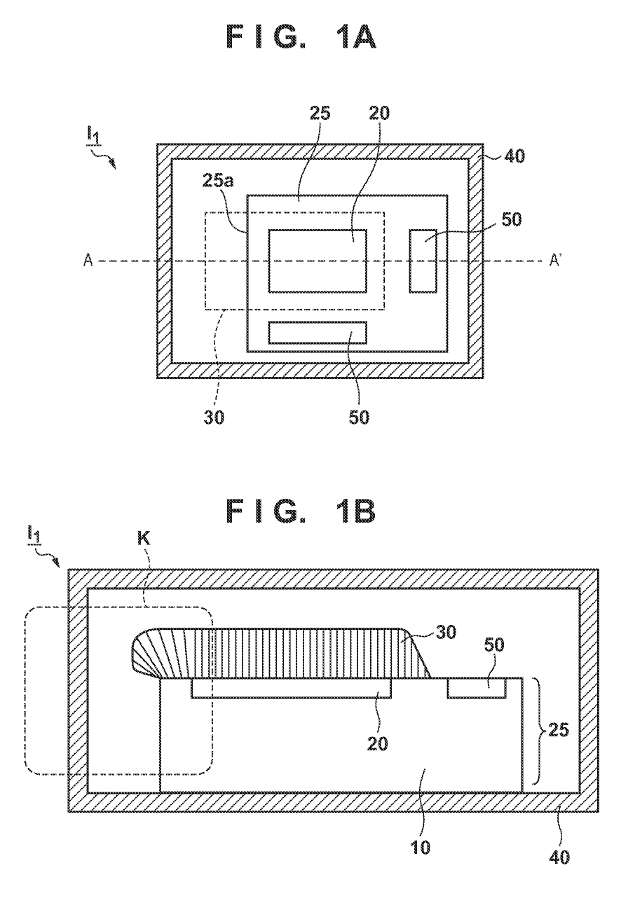

A radiation imaging apparatus I₁ according to an embodiment of the present invention will be described with reference to FIGS. 1A to 6E. FIG. 1A is a plan view of the radiation imaging apparatus I₁. FIG. 1B schematically shows a sectional structure taken along a cutline A-A′. The radiation imaging apparatus I₁ includes a sensor panel 25 and a scintillator layer 30. The sensor panel 25 includes a sensor array 20 having a plurality of sensors arranged on a substrate 10. The scintillator layer 30 is disposed on the sensor panel 25 so as to cover the sensor array 20. The scintillator layer 30 converts incident radiation into light. The sensor array 20 detects the light generated in the scintillator layer 30 in this manner. The substrate 10 is formed from an insulating member such as glass, a heat-resistant plastic, or silicon wafer member. The sensor array 20 forms an image sensing region, with each of the sensors arranged in the form of an array being constituted by, for example, a photoelectric conversion element, a switch element, a wiring for transmitting an electrical signal, and the like. The sensor panel 25 and the scintillator layer 30 can be installed in a housing 40. Each photoelectric conversion element is formed by using, for example, amorphous silicon and the like, and can include, for example, a MIS-type sensor and PIN-type sensor. A signal input/output unit 50 for controlling the sensor array 20 and reading out pixels signals can be disposed around the sensor array 20. A radiation image is obtained by performing predetermined signal processing for the read pixel signals. The housing 40 has a side wall facing a side surface of the sensor panel 25, and can contain a sensor panel 15 and the scintillator layer 30.

A sensor protection layer (not shown) for protecting the surface of the sensor array 20 can be disposed on the sensor panel 25. It is possible to use, for the sensor protection layer, SiN, TiO₂, LiF, Al₂O₃, MgO, and the like as well as resin-based members. The resin-based members include a fluorine resin, liquid crystal polymer, polyphenylene sulfide resin, polyether ether ketone resin, and polyether nitrile resin. The resin-based members also include a polysulfone resin, polyether sulfone resin, polyarylate resin, polyamide-imide resin, polyether-imide resin, polyimide resin, epoxy resin, and silicone resin. A material for the sensor protection layer may be selected to transmit light generated in the scintillator layer 30. A scintillator protection layer (not shown) can be formed on the scintillator layer 30 so as to cover the scintillator layer 30 to ensure moisture resistance.

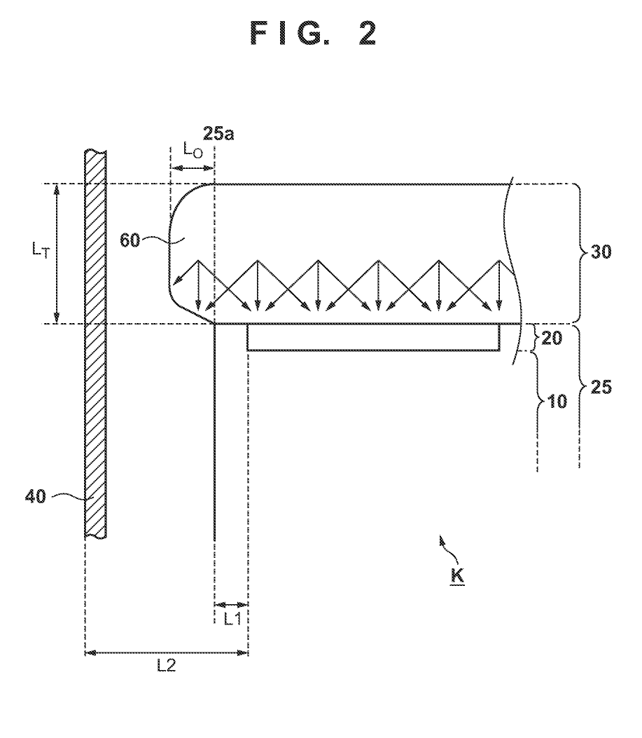

FIG. 2 is an enlarged view of an end region K of the sensor panel 25 and scintillator layer 30. The scintillator layer 30 protrudes from at least one side 25a of the sensor panel 25 toward a side wall which is a plate portion of a side surface of the housing 40. An outer edge of the scintillator layer 30 is located outside more than an outer edge of the sensor panel 25 at the one side 25a. As described above, the scintillator layer 30 has a protruding portion 60 protruding outside more than the outer edge of the sensor panel 25. The light generated in the protruding portion 60 enters the sensor array 20 as schematically indicated by the arrows in FIG. 2. Therefore, the sensitivity of the radiation imaging apparatus I₁ with respect to radiation is uniform within its plane. The signal input/output unit 50 can be generally disposed at an end portion of the sensor panel 25, and hence the protruding portion 60 may be formed on a side wherein the signal input/output unit 50 is not disposed. That is, although this embodiment exemplifies the case in which the protruding portion 60 is formed on the one side 25a of the sensor panel 25, protruding portions 60 may be formed at two or more sides. Note that the signal input/output unit 50 can be mounted on a mount board via a flexible cable (not shown) and the like.

According to the radiation imaging apparatus I₁ described above, the distribution of light generated in the scintillator layer 30 is made uniform. Therefore, when radiation is uniformly applied while an increase in a distance L2 from the housing 40 to the imaging region is suppressed, since the distribution of generated light is made uniform, it is possible to improve the quality of a radiation image. The short distance L2 from the housing 40 to the imaging region is advantageous in, for example, manufacturing a mammography. It is preferable to set a distance L₀ from the outer edge of the scintillator layer 30 to the outer edge of the sensor panel 25 such that a ratio L₀/L_{T} where L_{T} is the distance from the upper surface of the scintillator layer 30 to the bottom surface falls within the range of 1/4 to 1. In addition, the ratio L₀/L_{T} is preferably set to 1/3 or more to efficiently obtain the above effect, and is more preferably set to 1/2 or more.

The scintillator layer 30 may be formed by using a scintillator having a columnar crystal or by using a phosphor grain. For example, when using a scintillator having a columnar crystal, the columnar crystal can reduce the scattering of light generated in the scintillator layer 30. This can increase the resolution of a radiation image. As a material for this structure, a material containing an alkali halide as a main component. More specifically, such materials include CsI:Tl, CsI:Na, CsBr:Tl, NaI:Tl, LiI:Eu, and KI:Tl. When using CsI:Tl, for example, the scintillator layer 30 can be formed by a vapor deposition method using CsI and TlI.

When using a phosphor grain, the scintillator layer 30 can be easily formed by coating the sensor panel 25 with a phosphor paste obtained by dispersing a particulate crystal in a resin binder and drying the paste. As a material for this layer, for example, a known member such as CaWO₄, Gd₂O₂S:Tb, or BaSO₄:Pb may be used. The grain size of a phosphor grain may be set to, for example, about 5 μm to 100 μm, and preferably about 5 μm to 50 μm. A binder may be mixed with a known organic material. For example, a known resin may be used, including nitrocellulose, cellulose acetate, ethyl cellulose, polyvinyl butyral, polyester, vinyl chloride, vinyl acetate, acrylic resin, and polyurethane. As an organic solvent, a known member may be used, including ethanol, methyl ethyl ketone, butyl acetate, ethyl acetate, xylene, butyl carbitol, and terpineol. For example, the scintillator layer 30 is formed by coating the sensor panel 25 with the above phosphor paste by a general forming technique such as screen printing or slit coat printing and drying the paste.

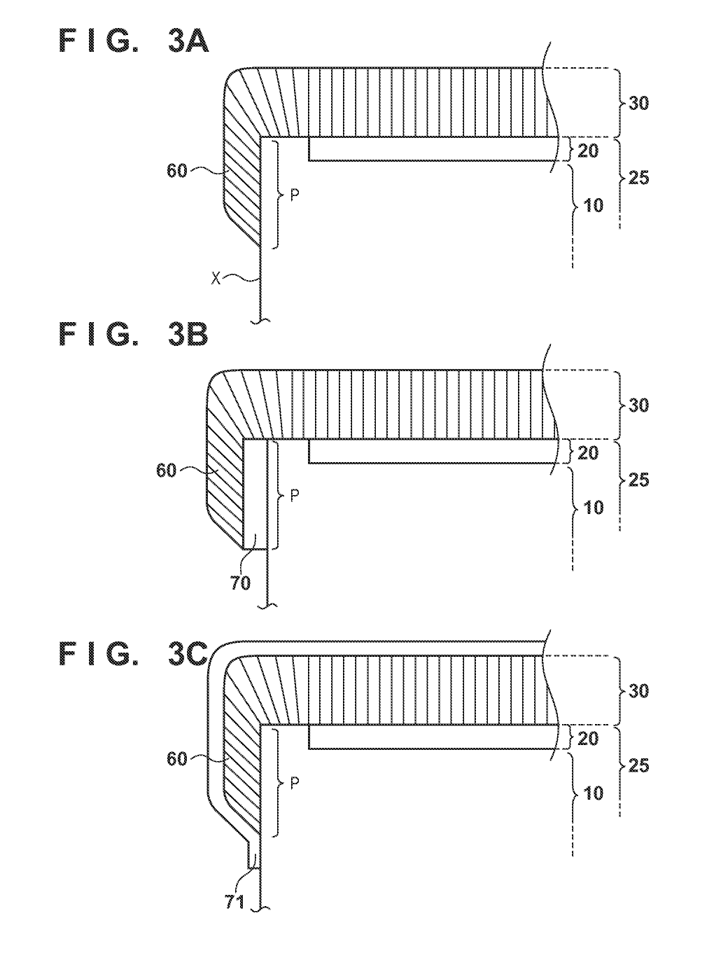

As exemplarily shown in FIG. 3A, the scintillator layer 30 may be formed on the one side 25a of the sensor panel 25 so as to cover at least a portion (portion P) of a side surface (surface X) of the sensor panel 25. The portion P is a portion of the surface X on which the scintillator layer 30 is disposed. Integrally forming the scintillator layer 30 allows it to be fixed more stably and to maintain its shape. Forming the scintillator layer 30 so as to cover at least a portion of side surface of the sensor panel 25 allows the scintillator layer 30 to be fixed more stably and improve the reliability of the radiation imaging apparatus I₁.

In addition, as exemplarily shown in FIG. 3B, an adhesion layer 70, which makes the substrate 10 to the scintillator layer 30, or a scintillator underlayer may be provided between the protruding portion 60 and the portion P. This stably fixes the scintillator layer 30 to the substrate 10 and maintains the shape of the protruding portion 60. This, for example, prevents the peeling of the scintillator layer 30 due to the stress caused by heat and the like, thereby improving the reliability of the radiation imaging apparatus I₁. A material to be used for the adhesion layer 70 may be a material which can resist against annealing in the process of forming a scintillator (for example, a temperature of about 200° C. or more when forming a scintillator having a columnar crystal structure). A material to be used for the adhesion layer 70 is, for example, a polyamide-imide resin, polyether-imide resin, polyimide resin, epoxy resin, or silicone resin. A material for the adhesion layer 70 may be selected so as to transmit light generated in the scintillator layer 30. The adhesion layer 70 may be provided on the entire surface X to form the scintillator layer 30 on the entire surface X. In addition, the adhesion layer 70 can also be formed on the upper surface of the sensor panel 25.

As exemplarily shown in FIG. 3C, a reflection layer 71 is formed to cover the scintillator layer 30. The reflection layer 71 reflects the light generated in the scintillator layer 30 toward the inside of the scintillator layer 30. The reflection layer 71 also covers the protruding portion 60 of the scintillator layer 30. This prevents the light generated in the protruding portion 60 from leaking outside and reflects the light toward the sensor array 20. A known material such as a metal like aluminum may be used for the reflection layer 71. In addition to the reflection layer 71, a protection film (not shown) for protecting the scintillator layer 30 may be formed. Alternatively, the reflection layer 71 also functioning as a protection layer may be formed.

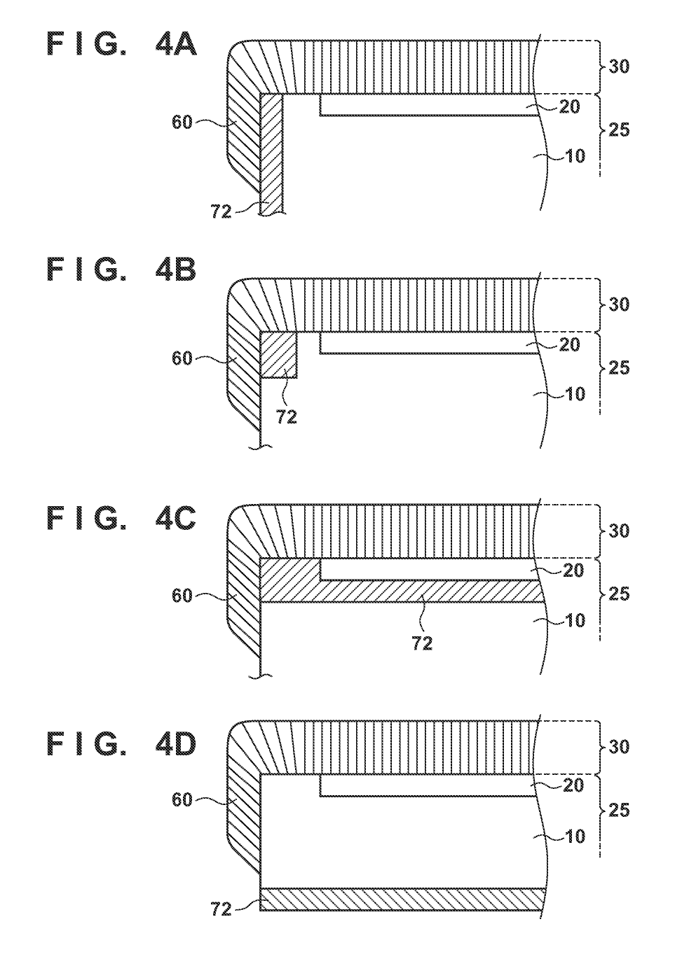

In addition, as exemplarily shown in FIGS. 4A to 4D, a light-shielding layer 72 or a member having a light-shielding property (to be simply referred to as a “light-shielding layer” hereinafter) may be disposed. For example, as exemplarily shown in FIG. 4A, the light-shielding layer 72 can be disposed between the protruding portion 60 and the sensor array 20 (for example, the surface X). This can prevent light from entering from the surface X side and improve the quality of a radiation image. As exemplarily shown in FIG. 4B, the light-shielding layer 72 may be formed in a region on the substrate 10 which is located outside the sensor array 20. Alternatively, as exemplarily shown in FIG. 4C, the light-shielding layer 72 may be formed before the formation of the sensor array 20 on the substrate 10, and the sensor panel 25 may be formed so as to dispose the sensor array 20 on the light-shielding layer 72, thereby preventing light from entering from the rear surface side or the side surface side. Alternatively, as exemplarily shown in FIG. 4D, the light-shielding layer 72 may be provided on the rear surface of the substrate 10, and a material for shielding against light with a desired wavelength may be used for the substrate 10 to make it function as a light-shielding layer.

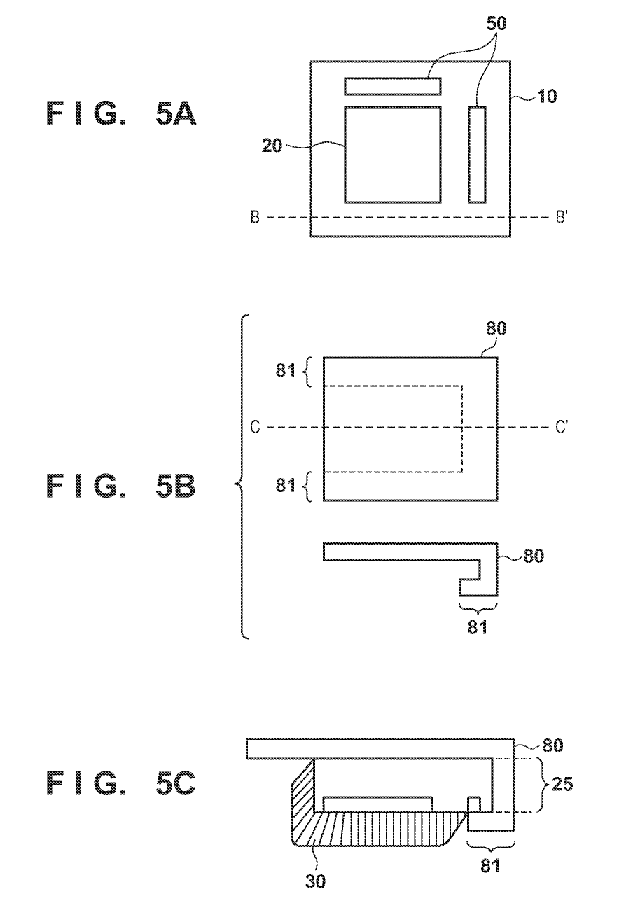

The radiation imaging apparatus I₁ is formed through mainly three steps. In the first step, the sensor array 20 is provided on the substrate 10, and the sensor panel 25 is prepared. This process may include, after the first step, the step of adjusting the shape of the sensor panel 25 for preparation for the second step, for example, cutting an end portion of the sensor panel 25 along one side of the sensor array 20 which is nearest to the end portion. More specifically, to form the protruding portion 60 described above in the second step of forming the scintillator layer 30, an end portion of the sensor panel 25 is cut along a cutline B-B′ along a side of the sensor array 20, as exemplarily shown in FIG. 5A. In this case, one of the two sides of the sensor panel 25 which do not have the signal input/output unit 50 is cut. However, the other side may be cut, and the scintillator layer 30 may be formed so as to protrude from the cut surface in the second step.

In the second step, the scintillator layer 30 is formed on the sensor panel 25. In this case, at the one side 25a of the sensor panel 25, the scintillator layer 30 is formed to protrude outside more than a side surface (the surface X in this case) of the sensor panel 25 at the one side 25a. FIG. 5B shows, on the upper side, a plan view of a holder 80 for holding the sensor panel 25 when performing a vapor deposition method, and a sectional view taken along a cutline C-C′ on the lower side. When, for example, forming the scintillator layer 30 by using a scintillator having a columnar crystal, it is preferable to inhibit the holder 80 from having a holder collar 81 for holding the sensor panel 25 at a position where the protruding portion 60 should be formed. Thereafter, the vapor deposition method is performed to also form the scintillator layer 30 on a side surface of the substrate 10 which corresponds to the portion which does not have the holder collar 81 (FIG. 5C). Although the above description has exemplified the case in which the holder 80 has only one side which does not have the holder collar 81. However, the holder 80 may have two or more sides which do not have holder collars 81 as long as the holder 80 can hold the sensor panel 25.

Forming a scintillator so as to grow a columnar crystal in an oblique direction can integrally form the scintillator layer 30. The angle of the columnar crystal of the scintillator layer 30 to be formed and thickness of the scintillator layer may be adjusted by the incident angle of a vapor deposition particles or the execution time of a vapor deposition step. In contrast to this, when forming the scintillator layer 30 by using a phosphor grain, the protruding portion 60 may be formed by adjusting the thixotropy or application amount of phosphor paste.

Subsequently, in the third step, the sensor panel 25 obtained in the second step is installed in the housing 40. In this case, the sensor panel 25 is installed so as to make the protruding portion 60 face in proximity the plate portion (side wall) of the side surface of the housing 40.

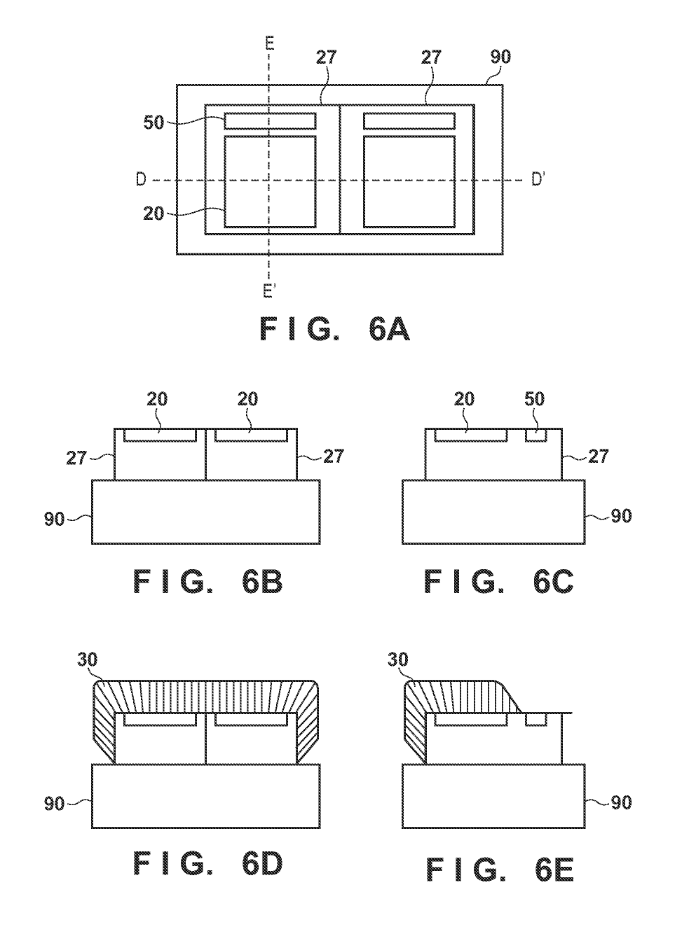

When manufacturing a large-screen radiation imaging apparatus exemplarily shown in FIGS. 6A to 6E, the sensor panel 25 may be acquired by juxtaposing a plurality of sensor units 27 each having a plurality of sensors. In this case, a large-area image sensing region is formed by arranging the two sensor units 27 on a support base 90 (FIG. 6A). FIG. 6B is a sectional view taken along a cutline D-D′. FIG. 6C is a sectional view taken along a cutline E-E′. Subsequently, in the above manner, the scintillator layer 30 may be formed by the vapor deposition method. FIG. 6D is a sectional view taken along a cutline D-D′ after the formation of the scintillator layer 30. FIG. 6E is a sectional view taken along a cutline E-E′ after the formation of the scintillator layer 30.

The present invention is not limited to the above embodiment. The objects, states, applications, functions, and other specifications of the present invention can be changed as needed, and other embodiments can implement the present invention. Examples of the present invention and their effects will be described below.

### EXAMPLE 1

A sensor panel 25 including a sensor array 20 having sensors arranged at a pitch of 160 μm and a signal input/output unit 50 was formed such that a distance L1 from an end of a substrate 10 which is located on the side where a protruding portion 60 of a scintillator layer 30 was formed to an image sensing region was 0.1 mm (see FIGS. 1A, 1B, and 2). CsI:Tl was used as a material for the scintillator layer 30, which was formed to have a thickness (that is, a distance L_{T}) of 500 μm. The vapor deposition step was performed such that the film formation rate became 10 μm/min and the maximum incident angle of a vapor deposition particles with respect to a side surface of the substrate 10 became 35°. This made the protruding portion 60, that is, the scintillator layer 30 on the side surface, have a thickness (distance L₀) of 250 μm.

Subsequently, a reflection layer 71 also functioning as the above protection layer was formed and mounted on a mount board, and the resultant structure was installed in a housing 40, thereby obtaining a radiation imaging apparatus. This radiation imaging apparatus improved the quality of a radiation image by equalizing the distribution of light generated upon uniform application of radiation while suppressing an increase in the distance from the housing 40 to the image sensing region.

### EXAMPLE 2

Example 2 differs from Example 1 in that a polyimide region (thickness: 3 μm) as a scintillator underlayer was formed on a surface on a substrate 10 made of glass on which a sensor array 20 was disposed and on a side surface of the substrate 10 on which a scintillator was to be formed (see FIGS. 3A to 3C). Thereafter, a vapor deposition step was performed as in Example 1 such that the maximum incident angle of a vapor deposition particles with respect to a side surface of the substrate 10 became 45°, thereby forming a scintillator layer 30 having a thickness (that is, a distance L_{T}) of 500 μm. A distance L₀ was 200 μm. Subsequently, a radiation imaging apparatus was obtained by the same procedure as that in Example 1. Example 2 obtains the same effect as that in Example 1, and also improves the adhesion property between the scintillator layer 30 and the side surface at a protruding portion 60. This maintains the shape of the protruding portion 60.

### EXAMPLE 3

Example 3 differs from Example 1 or 2 in that a polyimide region (thickness: 3 μm) as a scintillator underlayer was formed on a surface on a substrate 10 made of silicon on which a sensor array 20 was disposed and on a side surface of the substrate 10 on which a scintillator was to be formed (see FIGS. 3A to 3C and 4A to 4D). Thereafter, a vapor deposition step was performed as in Example 1 such that the maximum incident angle of a vapor deposition particles with respect to a side surface of the substrate 10 became 45°, thereby forming a scintillator layer 30 having a thickness (that is, a distance L_{T}) of 700 μm. A distance L₀ was 250 μm. Subsequently, a radiation imaging apparatus was obtained by the same procedure as that in Example 1. Example 3 obtains the same effect as that in Examples 1 and 2. In addition, since light with the emission wavelength generated in the scintillator layer 30 is transmitted through a polyimide resin but is not transmitted through the substrate 10, stray light entering from a side surface of the substrate 10 is shielded, thereby improving the quality of an obtained image.

### EXAMPLE 4

Example 4 obtained a large-screen radiation imaging apparatus by forming a sensor panel 25 by arranging a plurality of sensor units 27 on a support base 90 (see FIGS. 6A to 6E). In each sensor unit 27, a polyimide region (thickness: 3 μm) as a scintillator underlayer was formed on a surface on a substrate 10 made of silicon on which each sensor was disposed and on a side surface of the substrate 10 on which a scintillator was to be formed. Thereafter, a large-screen radiation imaging apparatus was obtained by the same procedure as each example. According to Example 4, the large-screen radiation imaging apparatus obtained the same effect as that in Examples 1 to 3.

### Example of Application to Radiation Imaging System

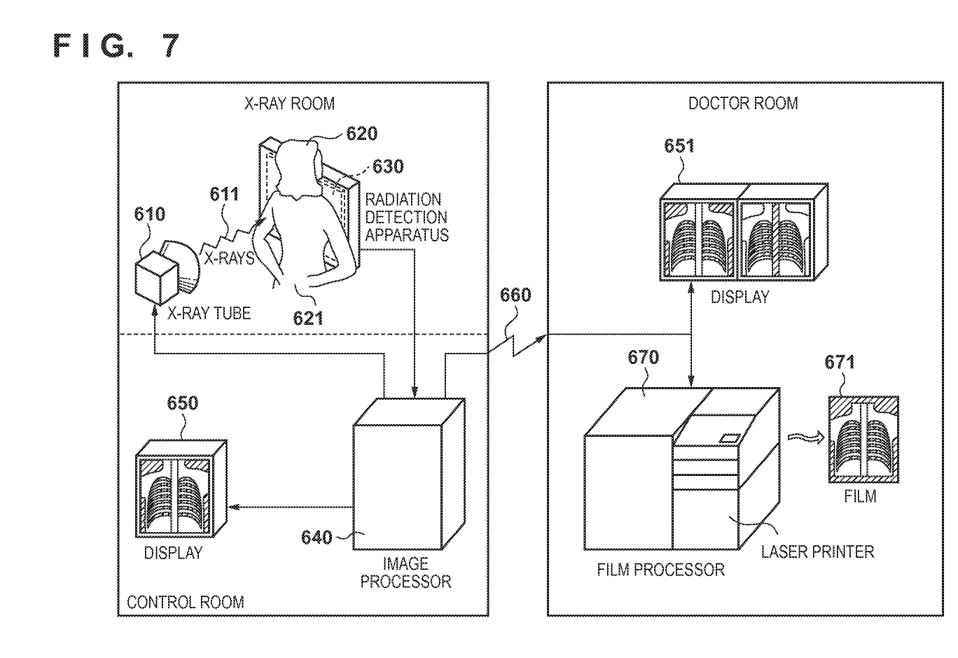

As exemplarily shown in FIG. 7, the radiation imaging apparatuses can be applied to a radiation imaging system. The radiation includes electromagnetic waves such as X-rays, α-rays, β-rays, and γ-rays. The following will exemplify the use of X-rays as a typical example. X-rays 611 generated by an X-ray tube 610 (radiation source) are transmitted through a chest region 621 of an object 620 such as a patient and enter a radiation imaging apparatus 630. The incident X-rays include information about the inside of the body of the patient 620. The scintillator emits light as X-rays enter, and electrical information is obtained by photoelectric conversion. This information is converted into a digital signal. An image processor 640 (signal processing unit) performs image processing of the signal. It is possible to observe the resultant image on a display 650 (display unit) in a control room.

In addition, it is possible to transfer this information to a remote place via a telephone line 660 (transmission processing unit). The transferred information can be displayed on, for example, a display 651 (display unit) installed in another place, for example, a doctor room. Furthermore, it is possible to store this information in a recording unit such as an optical disk. In this manner, another doctor in a remote place can diagnose the object. For example, a film processor 670 (recording unit) can record the information on a film 671 (recording medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-188925, filed Aug. 29, 2012, which is hereby incorporated by reference herein in its entirety.

What is claimed is:

1. A radiation imaging apparatus comprising:
a sensor panel including a sensor array;
a scintillator layer disposed on the sensor panel so as to cover the sensor array; and
a housing having a side wall facing a side surface of the sensor panel and containing the sensor panel and the scintillator layer,
wherein the scintillator layer protrudes, at at least one side of the sensor panel, from the side toward the side wall.

2. The apparatus according to claim 1, wherein the scintillator layer is formed, at the at least one side, so as to cover at least a portion of a side surface of the sensor panel.

3. The apparatus according to claim 2, further comprising an adhesion layer configured to make the sensor panel adhere to the scintillator layer between the at least portion of the side surface of the sensor panel and a portion where the scintillator layer covers the at least portion.

4. The apparatus according to claim 2, further comprising a layer having a light-shielding property and disposed between the sensor array and the at least portion of the side surface of the sensor panel.

5. The apparatus according to claim 1, wherein a distance from an outer edge of the scintillator layer to an outer edge of the sensor panel falls within a range of 1/3 times to 1 time of a distance from an upper surface to a bottom surface of the scintillator layer.

6. The apparatus according to claim 1, wherein the at least portion of the side surface of the sensor panel comprises a portion of the side surface which is located on a side where the scintillator layer is disposed, and the scintillator layer is integrally formed.

7. The apparatus according to claim 1, further comprising a reflection layer formed to cover the scintillator layer and configured to reflect light generated in the scintillator layer toward inside the scintillator layer.

8. A radiation imaging system comprising:
a radiation imaging apparatus defined in claim 1; and
a radiation source configured to generate radiation.

9. A method for manufacturing a radiation imaging apparatus, the method comprising:
preparing a sensor panel, forming a scintillator layer on the sensor panel so as to protrude from at least one side of the sensor panel to outside more than a side surface of the sensor panel at the one side, and containing the sensor panel and the scintillator layer in a housing,
wherein in the containing the sensor panel and the scintillator layer, a side wall of the housing faces a side wall of the sensor panel, and the scintillator layer is formed to protrude from the at least one side of the sensor panel to the side wall of the housing.

10. The method according to claim 9, wherein the preparing the sensor panel comprises providing a sensor array on a substrate and cutting an end portion of the substrate along one side of the sensor array which is nearest to the end portion, and in the forming the scintillator layer, the one side which is cut in the cutting is treated as the at least one side of the sensor panel.

11. The method according to claim 9, wherein in the preparing the sensor panel, the sensor panel is formed by arraying a plurality of sensor units so as to neighbor each other, each of the plurality of sensor units has a plurality of sensors.
